(19) United States
(12) Patent Application Publication
(10) Pub. No.: US 2009/0105922 A1
(43) Pub. Date: Apr. 23, 2009

(54) TRAVEL CONTROL DEVICE

(75) Inventor: Mitsuhiko Morita, Shizuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Aichi (JP)

(21) Appl. No.: 11/917,806

(22) PCT Filed: Jun. 15, 2006
(86) PCT No.: PCT/JP2006/312455

§ 371 Date: Dec. 17, 2007

(30) Foreign Application Priority Data
Jun. 15, 2005 (JP) 2005-175376

(51) Int. Cl. G06F 7/00

(52) U.S. Cl. 701/96

(57) ABSTRACT

A running control apparatus for controlling a running state of a vehicle by adjusting acceleration and deceleration of the vehicle releases the running control in case of a predetermined steering operation or more while the vehicle is stopped during the running control. This prevents the vehicle from running in a direction not intended by a driver at the time of starting, and the driver can be prevented from feeling a sense of discomfort at that time. Preventing the vehicle from starting in the direction not intended by the driver can also improve the running safety. This can restrain the vehicle from running in a way not intended by the driver upon a steering operation while the vehicle is stopped.

### TECHNICAL FIELD

The present invention relates to a running control apparatus which controls a running state of a vehicle.

### BACKGROUND ART

As described in Japanese Patent Application Laid-Open No. 2002-293160, a running control apparatus which detects the distance between its own vehicle and a preceding vehicle and controls the speed of the own vehicle according to the inter-vehicle distance, so as to follow the preceding vehicle has conventionally been known as one concerning a running control apparatus which controls a running state of the vehicle. This running control apparatus is provided with operation detecting means for detecting driver's accelerating and decelerating operations, and cancels follow-up control in case of an accelerating or decelerating operation at the time when the own vehicle is automatically stopped as the preceding vehicle stops during the follow-up control, so as to prevent the follow-up control from being performed against the driver's will.

### DISCLOSURE OF THE INVENTION

If the steering wheel is turned while the own vehicle is automatically stopped, however, such an apparatus will cause the vehicle to advance, at the time of starting, in a direction different from the course of the vehicle before the stop. At this time, the driver may feel a sense of discomfort because of the vehicle running in an unintended direction.

It is therefore an object of the present invention to provide a running control apparatus which restrains the vehicle from running in a way not intended by the driver when the steering wheel is operated while the vehicle is stopped.

Namely, the running control apparatus in accordance with the present invention is a running control apparatus for controlling a running state of a vehicle by adjusting a physical quantity concerning a speed of the vehicle, the apparatus comprising steering detecting means for detecting a steering operation of the vehicle, and running control means for suppressing the running control in case of the steering operation while the vehicle is stopped during the running control.

If the steering wheel is operated while the vehicle is stopped during the running control, this invention will suppress the running control such as running speed limitation, running acceleration limitation, and running control release, and thus can restrain the vehicle from running in a direction not intended by the driver after being stopped and the driver from feeling a sense of discomfort. Restraining the vehicle from starting in the direction not intended by the driver can also improve the running safety.

Preferably, in the running control apparatus in accordance with the present invention, the running control means releases the running control in case of the steering operation while the vehicle is stopped during the running control.

This invention releases the running control in case of the steering operation while the vehicle is stopped during the running control. This can prevent the vehicle from starting in a direction not intended by the driver after being stopped and the driver from feeling a sense of discomfort. Preventing the vehicle from starting in the direction not intended by the driver can also improve the running safety.

Preferably, in the running control apparatus in accordance with the present invention, the running control means limits acceleration of the vehicle in the running control in case of the steering operation while the vehicle is stopped during the running control.

This invention performs acceleration limitation in the running control in case of the steering operation while the vehicle is stopped during the running control. This can prevent the vehicle from suddenly starting in a direction not intended by the driver after being stopped and the driver from feeling a sense of discomfort. Preventing the vehicle from suddenly starting in the direction not intended by the driver can also improve the running safety.

Preferably, in case of acceleration limitation of the vehicle in the running control in the running control apparatus in accordance with the present invention, the running control means releases the acceleration limitation when the speed of the vehicle is a predetermined speed or higher.

In case of acceleration limitation of the vehicle in the running control, this invention releases the acceleration limitation when the speed of the vehicle is a predetermined speed or higher, thereby making it possible to continue the running control without restarting the same.

Preferably, in case of acceleration limitation of the vehicle in the running control in the running control apparatus in accordance with the present invention, the running control means releases the acceleration limitation in case of a steering returning operation.

In case of acceleration limitation of the vehicle in the running control, this invention releases the acceleration limitation when there is a steering returning operation, thereby making it possible to continue the running control without restarting the same.

Preferably, the running control apparatus in accordance with the present invention controls the running state of the vehicle by adjusting the physical quantity concerning the speed such as to maintain an inter-vehicle distance to a preceding vehicle in a predetermined state.

### BRIEF DESCRIPTION OF THE DRAWINGS

FIG. 1 is a schematic diagram of the running control apparatus in accordance with a first embodiment of the present invention;

FIG. 2 is a flowchart showing a running control release process in the running control apparatus of FIG. 1;

FIG. 3 is a flowchart of an acceleration limitation process in the running control apparatus in accordance with a second embodiment; and

FIG. 4 is a flowchart of an acceleration limitation process in the running control apparatus in accordance with a third embodiment.

### BEST MODES FOR CARRYING OUT THE INVENTION

In the following, embodiments of the present invention will be explained in detail with reference to the accompanying drawings. In the explanation of the drawings, the same constituents will be referred to with the same numerals while omitting their overlapping descriptions.

### First Embodiment

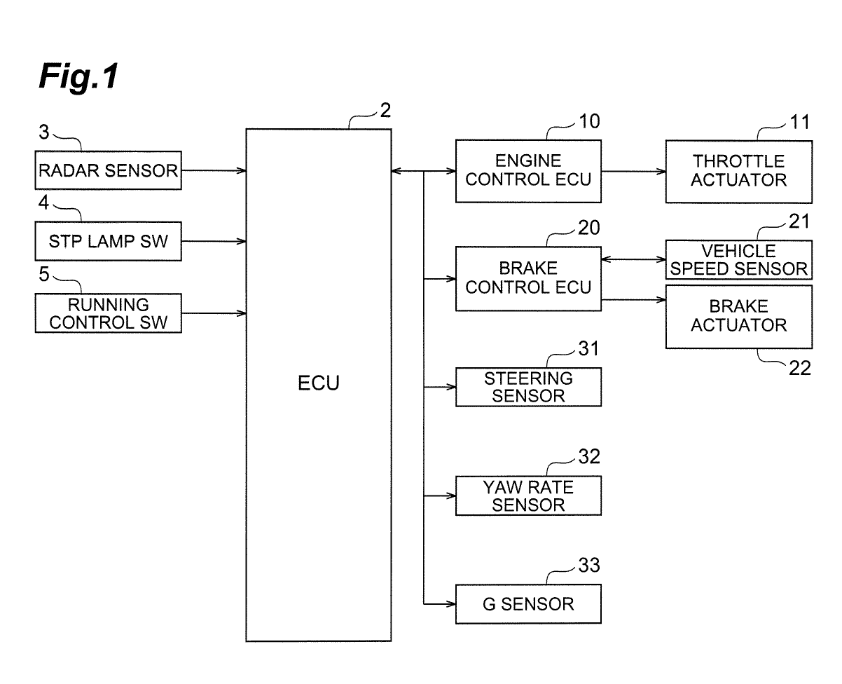

FIG. 1 is a schematic diagram of the running control apparatus in accordance with the first embodiment of the present invention. The running control apparatus in accordance with this embodiment is an apparatus which is mounted in a vehicle and makes it follow a preceding vehicle. Namely, this apparatus controls the running state of the vehicle by adjusting the speed or acceleration (physical quantity concerning the speed) such as to maintain the inter-vehicle distance to the preceding vehicle in a predetermined state. The running control apparatus is equipped with an ECU 2. The ECU 2, which performs running control, is mainly constituted by a computer including CPU, ROM, and RAM, for example.

The ECU 2 is connected to a radar sensor 3, a stop lamp switch 4, and a running control switch 5. The radar sensor 3 functions as a distance measuring means which measures the distance between the vehicle and the preceding vehicle running in front thereof. As the radar sensor 3, one utilizing radio waves such as millimeter waves is used, for example. Distance information issued from the radar sensor 3 is fed into the ECU 2.

The stop lamp switch 4 functions as a detecting means for detecting stops of the vehicle. Vehicle stop information issued from the stop lamp switch 4 is fed into the ECU 2. The running control switch 5 is a switch for starting and releasing the running control, and is operated by the driver, so as to start or release follow-up running control.

The ECU 2 is also connected to an engine control ECU 10, a brake control ECU 20, a steering sensor 31, a yaw rate sensor 32, and a lateral acceleration sensor (G sensor) 33. Inputs and outputs of signals, data, and the like are performed between the ECU 2 and the engine control ECU 10, brake control ECU 20, steering sensor 31, yaw rate sensor 32, and lateral acceleration sensor 33 through CAN (Controller Area Network) communications, for example.

The ECU 2 issues an acceleration order signal, a deceleration order signal, and the like to the engine control ECU 10 according to the inter-vehicle distance to the preceding vehicle. The engine control ECU 10 actuates a throttle actuator 11 according to the order signals, so as to control the driving state of the engine. Also, the ECU 2 issues a brake actuation order signal, a brake release order signal, and the like to the brake control ECU 20 according to the inter-vehicle distance to the preceding vehicle. The brake control ECU 20 actuates or stops actuating a brake actuator 22 according to the order signals, so as to control the brake actuation state.

The brake control ECU 20 is connected to a vehicle speed sensor 21. The vehicle speed sensor 21 functions as a vehicle speed detecting means which detects the running speed of the own vehicle. The ECU 2 can acquire vehicle speed information of the vehicle speed sensor 21 through the brake control ECU 20. The steering sensor 31 detects the steering angle of the steering wheel of the vehicle, and functions as a steering detecting means which detects steering operations of the vehicle. The yaw rate sensor 32 detects the yaw rate of the vehicle. The G sensor 33 is a sensor which detects the lateral acceleration of the vehicle.

Operations of the running control apparatus in accordance with this embodiment will now be explained.

First, a basic operation of the running control apparatus will be explained. When the running control switch 5 is turned on, the running control apparatus performs automatic running control such as to follow the preceding vehicle. The radar sensor 3 measures the distance to the preceding vehicle.

When the measured distance is longer than a predetermined distance which has been set beforehand, for example, the ECU 2 issues the acceleration order signal to the engine control ECU 10. When the measured distance is shorter than the predetermined distance, on the other hand, the ECU 2 issues the deceleration order signal to the engine control ECU 10 or the brake actuation order signal to the brake control ECU 20.

When the preceding vehicle is decelerated and then stopped, the ECU 2 issues the brake actuation order signal to the brake control ECU 20 so as to maintain the predetermined distance. When the preceding vehicle is started from the stop state, the ECU 2 issues the brake release order signal to the brake ECU 20 and the acceleration order signal to the engine ECU 10. Thus, as the vehicle is accelerated and decelerated, the inter-vehicle distance to the preceding vehicle is maintained in a predetermined state.

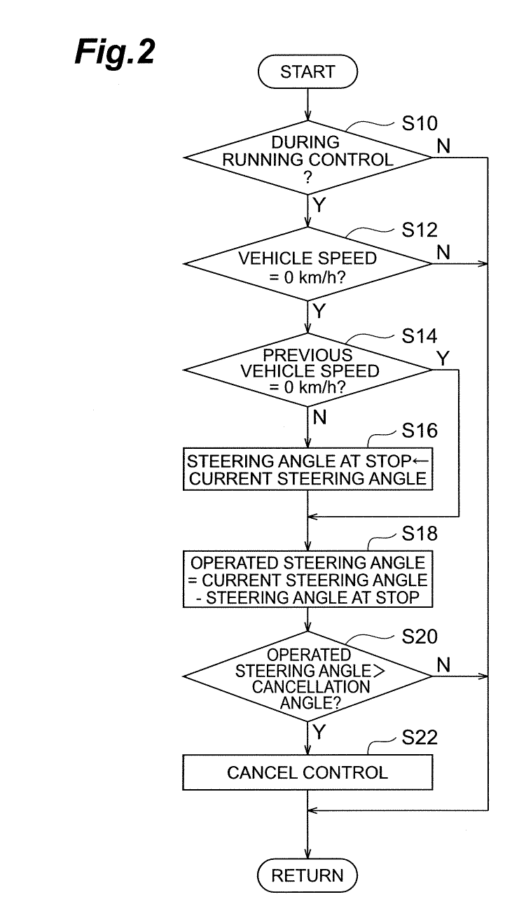

FIG. 2 is a flowchart of a running control release process in the running control apparatus in accordance with this embodiment. This running control release process is a process for releasing the running control operation in case of a steering operation while the vehicle is stopped during the running control. Turning on the ignition executes the running control release process in the ECU 2 repeatedly in a predetermined period.

First, as shown at S10 in FIG. 2, whether the running control is in effect or not is determined. If the running control is not in effect, the control process is terminated. If the running control is in effect, on the other hand, whether the vehicle speed is 0 km/h or not is determined (S12). The vehicle speed state is determined according to the detection signal of the vehicle speed sensor 21. If the vehicle speed is not 0 km/h, the control process is terminated. If the vehicle speed is 0 km/h, on the other hand, whether the previous vehicle speed value is 0 km/h or not is determined (S14). The previous vehicle speed value refers to the vehicle speed value before acquiring the current vehicle speed value. This vehicle speed value is updated in a predetermined period.

If the previous vehicle speed value is 0 km/h at S14, it is determined that the vehicle has already been in its stop state, and the flow proceeds to S18. If the previous vehicle speed value is not 0 km/h at S14, on the other hand, it is determined that the vehicle has just stopped, and the current steering angle is recorded as the steering angle at the stop (S16). The steering angle based on the detection signal of the steering sensor 31 is used as the current steering angle.

Then, the flow proceeds to S18, where an operated steering angle is calculated. The operated steering angle is calculated by subtracting the steering angle at the stop from the current steering angle. Preferably, the absolute value of the value obtained by subtracting the steering angle at the stop from the current steering angle is used as the operated steering angle in this case. Subsequently, the flow proceeds to S20, where it is determined whether the operated steering angle is greater than a cancellation angle or not. The cancellation angle is a preset angle which has been set beforehand in the ECU 2.

If the operated steering angle is not greater than the cancellation angle at S20, the control process is terminated. If the operated steering angle is greater than the cancellation angle, on the other hand, a control canceling process is performed (S22). The control canceling process is a process for releasing the automatic running control. Executing this control canceling process releases the running control for automatically following the preceding vehicle, thus attaining a vehicle running state based on accelerating operations by the driver. After the processing of S22 ends, this control process is terminated.

As in the foregoing, the running control apparatus in accordance with this embodiment releases the running control in case of a steering operation by a predetermined amount or more (cancellation angle or more) while the vehicle is stopped during the running control. This can prevent the vehicle from beginning to run in an unintended direction at the time of starting after being stopped and the driver from feeling a sense of discomfort. Preventing the vehicle from starting in the direction not intended by the driver can also improve the running safety of the vehicle.

### Second Embodiment

The running control apparatus in accordance with the second embodiment of the present invention will now be explained.

The running control apparatus in accordance with this embodiment has a hardware structure similar to that of the running control apparatus in accordance with the first embodiment shown in FIG. 1, but differs therefrom in that acceleration limitation is performed in the running control in case of a predetermined steering operation or more while the vehicle is stopped during the running control.

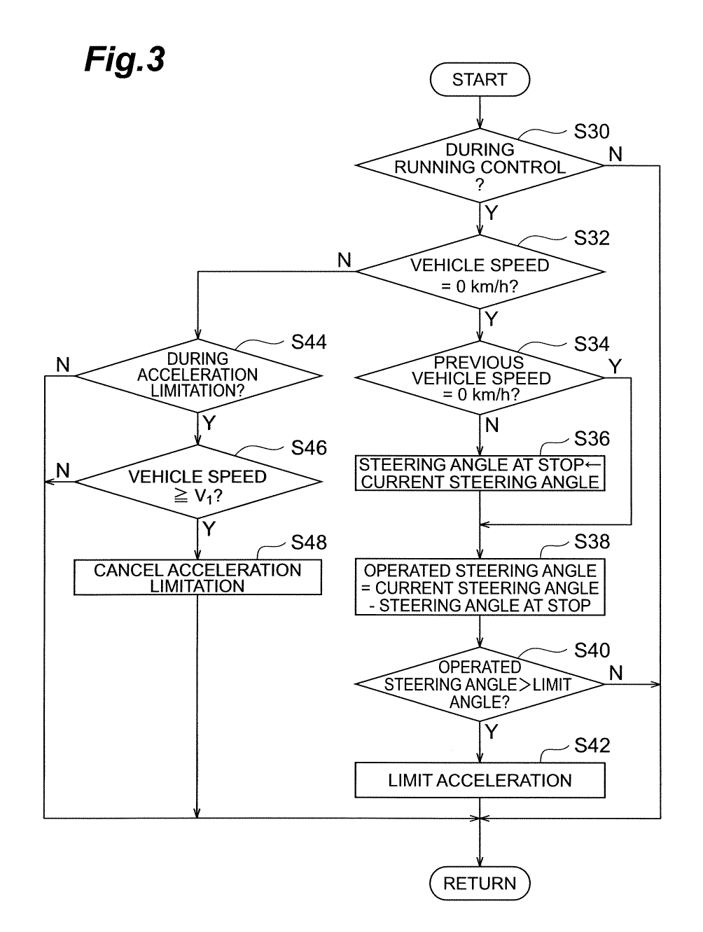

FIG. 3 is a flowchart of an acceleration limitation process in the running control apparatus in accordance with this embodiment. This acceleration limitation process is a process for performing acceleration limitation of the vehicle in the running control in case of a predetermined steering operation or more while the vehicle is stopped during the running control. Turning on the ignition executes the acceleration limitation process in the ECU 2 repeatedly in a predetermined period.

First, as shown at S30 in FIG. 3, it is determined whether the running control is in effect or not. If the running control is not in effect, the control process is terminated. If the running control is in effect, on the other hand, whether the vehicle speed is 0 km/h or not is determined (S32). The vehicle speed state is determined according to the detection signal of the vehicle speed sensor 21. If it is determined that the vehicle speed is 0 km/h at S32, whether the previous vehicle speed value is 0 km/h or not is determined (S34). The previous vehicle speed value refers to the vehicle speed value before acquiring the current vehicle speed value. This vehicle speed value is updated in a predetermined period.

If the previous vehicle speed value is 0 km/h at S34, it is determined that the vehicle has already been in its stop state, and the flow proceeds to S38. If the previous vehicle speed value is not 0 km/h at S34, on the other hand, it is determined that the vehicle has just stopped, and the current steering angle is recorded as the steering angle at the stop (S36). The steering angle based on the detection signal of the steering sensor 31 is used as the current steering angle.

Then, the flow proceeds to S38, where an operated steering angle is calculated. The operated steering angle is calculated by subtracting the steering angle at the stop from the current steering angle. Preferably, the absolute value of the value obtained by subtracting the steering angle at the stop from the current steering angle is used as the operated steering angle in this case. Subsequently, the flow proceeds to S40, where it is determined whether the operated steering angle is greater than an acceleration limit angle or not. The acceleration limit angle is a preset angle which has been set beforehand in the ECU 2.

If the operated steering angle is not greater than the acceleration limit angle at S40, the control process is terminated. If the operated steering angle is greater than the acceleration limit angle, on the other hand, an acceleration limitation process is performed (S42). The acceleration limitation process is a process for prohibiting a predetermined acceleration or more in the running control. Executing this acceleration limitation process prevents the vehicle from being accelerated by a predetermined amount or more when the running control for automatically following the preceding vehicle is performed.

If it is determined that the vehicle speed is not 0 km/h at S32, it is determined whether acceleration limitation is in effect or not (S44). If it is determined that the acceleration limitation is not in effect, the control process is terminated. If it is determined that the acceleration limitation is in effect, on the other hand, it is determined whether the vehicle speed is at least V1 or not (S46). V1 is a vehicle speed value which has been set, e.g., to 15 km/h, beforehand in the ECU 2. If it is determined that the vehicle speed is below V1 at S46, the control process is terminated.

If the vehicle speed is at least V1 in S46, it is determined that the driver wishes to continue the running control without braking operations and the like even in case of the steering operation or acceleration limitation when stopped, and an acceleration limitation release process is performed (S48). The acceleration limitation release process is a process for releasing the acceleration limitation control in the running control and returning it to normal running control.

As in the foregoing, the running control apparatus in accordance with this embodiment executes acceleration limitation in the running control in case of a steering operation by a predetermined amount or more (cancellation angle or more) while the vehicle is stopped during the running control. This can prevent the vehicle from suddenly starting in a direction not intended by the driver at the time of starting after being stopped and the driver from feeling a sense of discomfort. Preventing the vehicle from suddenly starting in the direction not intended by the driver can also improve the running safety of the vehicle.

Also, the running control apparatus in accordance with this embodiment releases the acceleration limitation when the vehicle reaches a predetermined speed or higher in case of acceleration limitation by the running control. This makes it unnecessary for the driver wishing to continue the normal running control to restart the running control by pushing the running control switch 5 and so forth, whereby the running control can be continued. Therefore, the convenience of using the apparatus can be improved.

### Third Embodiment

The running control apparatus in accordance with the third embodiment of the present invention will now be explained.

The running control apparatus in accordance with this embodiment has a hardware structure similar to that of the running control apparatus in accordance with the first embodiment shown in FIG. 1, but differs therefrom in that acceleration limitation is performed in the running control in case of a predetermined steering operation or more while the vehicle is stopped during the running control. This acceleration limitation control is similar to that in the running control apparatus in accordance with the second embodiment, but the method of releasing the acceleration limitation in the latter differs from that in the running control apparatus in accordance with the third embodiment.

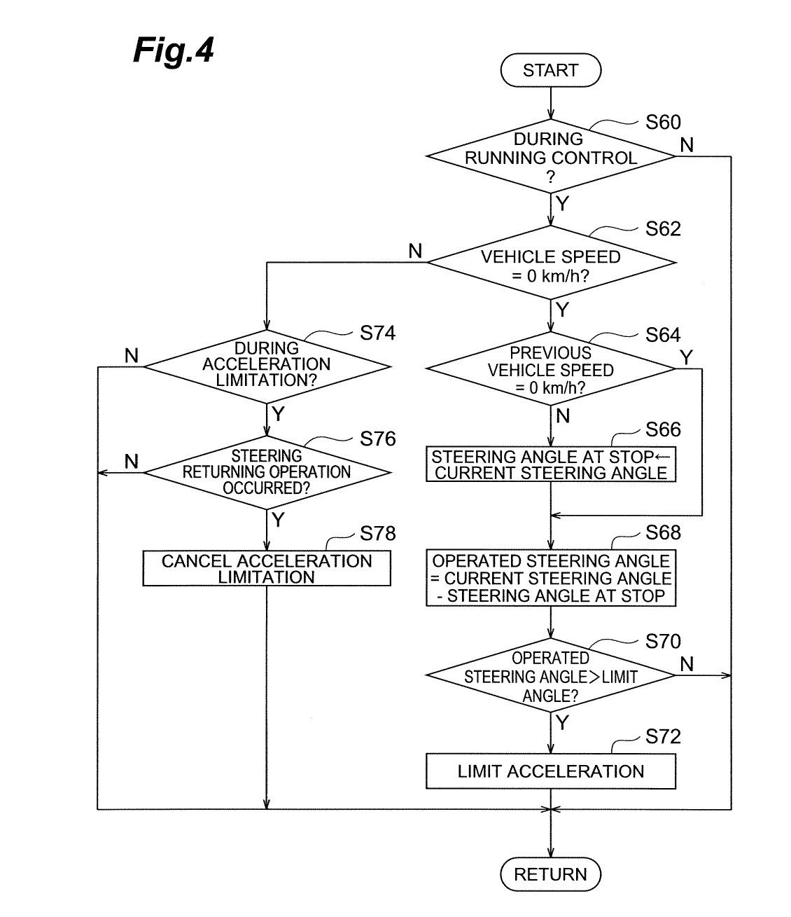

FIG. 4 is a flowchart of an acceleration limitation process in the running control apparatus in accordance with this embodiment. This acceleration limitation process is a process for performing acceleration limitation of the vehicle in the running control in case of a predetermined steering operation or more while the vehicle is stopped during the running control. Turning on the ignition executes the acceleration limitation process in the ECU 2 repeatedly in a predetermined period.

First, as shown at S60 in FIG. 4, it is determined whether the running control is in effect or not. If the running control is not in effect, the control process is terminated. If the running control is in effect, on the other hand, whether the vehicle speed is 0 km/h or not is determined (S62). The vehicle speed state is determined according to the detection signal of the vehicle speed sensor 21. If it is determined that the vehicle speed is 0 km/h at S62, whether the previous vehicle speed value is 0 km/h or not is determined (S64). The previous vehicle speed value refers to the vehicle speed value before acquiring the current vehicle speed value. This vehicle speed value is updated in a predetermined period.

If the previous vehicle speed value is 0 km/h at S64, it is determined that the vehicle has already been in its stop state, and the flow proceeds to S68. If the previous vehicle speed value is not 0 km/h at S64, on the other hand, it is determined that the vehicle has just stopped, and the current steering angle is recorded as the steering angle at the stop (S66). The steering angle based on the detection signal of the steering sensor 31 is used as the current steering angle.

Then, the flow proceeds to S68, where an operated steering angle is calculated. The operated steering angle is calculated by subtracting the steering angle at the stop from the current steering angle. Preferably, the absolute value of the value obtained by subtracting the steering angle at the stop from the current steering angle is used as the operated steering angle in this case. Subsequently, the flow proceeds to S70, where it is determined whether the operated steering angle is greater than an acceleration limit angle or not. The acceleration limit angle is a preset angle which has been set beforehand in the ECU 2.

If the operated steering angle is not greater than the acceleration limit angle at S70, the control process is terminated. If the operated steering angle is greater than the acceleration limit angle, on the other hand, an acceleration limitation process is performed (S72). The acceleration limitation process is a process for prohibiting a predetermined acceleration or more in the running control. Executing this acceleration limitation process prevents the vehicle from being accelerated by a predetermined amount or more when the running control for automatically following the preceding vehicle is performed.

If it is determined that the vehicle speed is not 0 km/h at S62, it is determined whether acceleration limitation is in effect or not (S74). If it is determined that the acceleration limitation is not in effect, the control process is terminated. If it is determined that the acceleration limitation is in effect, on the other hand, it is determined whether there is a steering returning operation or not (S76). It will be sufficient if whether or not there is a steering returning operation is determined according to whether or not the current steering angle has been returned to the steering angle at the stop. This may also be determined according to whether the current steering angle has been returned from the steering angle at the stop such as to fall within a predetermined angle range or not. If it is determined that there is no steering returning operation at S76, the control process is terminated.

If it is determined that there is a steering returning operation at S76, on the other hand, it is determined that the running direction of the vehicle has been returned to the direction intended by the driver, and an acceleration limitation release process is performed (S78). The acceleration limitation release process is a process for releasing the acceleration limitation control in the running control and returning it to normal running control.

As in the foregoing, the running control apparatus in accordance with this embodiment executes acceleration limitation in the running control in case of a steering operation by a predetermined amount or more (acceleration limit angle or more) while the vehicle is stopped during the running control. This can prevent the vehicle from suddenly starting in a direction not intended by the driver at the time of starting after being stopped and the driver from feeling a sense of discomfort. Preventing the vehicle from suddenly starting in the direction not intended by the driver can also improve the running safety of the vehicle.

Also, the running control apparatus in accordance with this embodiment releases the acceleration limitation when there is a steering returning operation in case of acceleration limitation by the running control. This makes it unnecessary for the driver wishing to continue the normal running control to restart the running control by pushing the running control switch 5 and so forth, whereby the running control can be continued. Therefore, the convenience of using the apparatus can be improved.

The running control apparatus in accordance with the above-mentioned embodiments illustrate a part of examples of the running control apparatus in accordance with the present invention. Therefore, the running control apparatus in accordance with the present invention is not limited to them, but may also be those modifying the apparatus in accordance with the embodiments without altering the gist described in each claim.

### INDUSTRIAL APPLICABILITY

The present invention can restrain a vehicle from running in a way not intended by the driver when the steering wheel is operated while the vehicle is stopped.

1. A running control apparatus for controlling a running state of a vehicle by adjusting a speed or acceleration of the vehicle such as to follow a preceding vehicle while maintaining an inter-vehicle distance thereto in a predetermined state, the apparatus comprising:
steering detecting means for detecting a steering operation of the vehicle; and
running control means for suppressing the running control in case of the steering operation while the vehicle is stopped during the running control.

2. A running control apparatus according to claim 1, wherein the running control means releases the running control in case of the steering operation while the vehicle is stopped during the running control.

3. A running control apparatus according to claim 1, wherein the running control means limits acceleration of the vehicle in the running control in case of the steering operation while the vehicle is stopped during the running control.

4. A running control apparatus according to claim 3, wherein, in case of acceleration limitation of the vehicle in the running control, the running control means releases the acceleration limitation when the speed of the vehicle is a predetermined speed or higher.

5. A running control apparatus according to claim 3, wherein, in case of acceleration limitation of the vehicle in the running control, the running control means releases the acceleration limitation in case of a steering returning operation.

6. (canceled)

7. A running control apparatus for a vehicle comprising:
a running controller that performs a running control of the vehicle such as to follow a preceding vehicle while maintaining an inter-vehicle distance thereto in a predetermined distance; and
a steering sensor that detects a steering operation of the vehicle;
wherein the running controller suppresses the running control when the running controller receives a steering operation signal from the steering sensor while the vehicle is stopped during the running control.

8. A running control apparatus according to claim 7, wherein the running controller releases the running control when the running controller receives the steering operation signal from the steering sensor while the vehicle is stopped during the running control.

9. A running control apparatus according to claim 7, wherein the running controller limits acceleration of the vehicle in the running control when the running controller receives the steering operation signal from the steering sensor while the vehicle is stopped during the running control.

10. A running control apparatus according to claim 9, wherein, in case of acceleration limitation of the vehicle in the running control, the running controller releases the acceleration limitation when the speed of the vehicle becomes a predetermined speed or higher.

11. A running control apparatus according to claim 9, wherein, in case of acceleration limitation of the vehicle in the running control, the running controller releases the acceleration limitation when the running controller receives a steering returning operation signal from the steering sensor.
